(19) United States
(12) Patent Application Publication
(10) Pub. No.: US 2007/0059548 A1
(43) Pub. Date: Mar. 15, 2007

(54) Grid array package using tin/silver columns

(75) Inventors: David G. Love, Pleasanton, CA (US); Bidyut Sen, Palo Alto, CA (US)

Correspondence Address: SUN MICROSYSTEMS, INC.;ATTN: TIMOTHY SCHULTE, ONE STORAGETEK DRIVE, MS 4309, LOUISVILLE, CO, 80028-4309, US

(73) Assignee: Sun Microsystems, Inc.

(21) Appl. No.: 11/211,246

(22) Filed: Aug. 25, 2005

Related U.S. Application Data
(60) Provisional application No. 60/708,837, filed on Aug. 17, 2005.

(51) Int. Cl. C22C 13/00; B32B 15/01

(52) U.S. Cl. 428/610; 420/560; 428/646

(57) ABSTRACT

Techniques have been developed to provide, in some embodiments, an attachment structure for mechanically and electrically connecting substrates that is robust to differences in coefficients of thermal expansion. In some realizations lead-free alloy columns are joined to bonding pads on electronic packages having relatively low coefficients of thermal expansion (CTEs) using Pb-free solder from the same alloy system. In some embodiments, a thermal hierarchy in the tin-silver-copper (Sn—Ag—Cu or SAC) ternary alloy system is provided. In some embodiments an attachment system with a high-liquidus alloy column, an intermediate-liquidus solder, and a low-liquidus solder, all three of which components have compositions in the SAC alloy system, is provided.

### BACKGROUND

1. Field of the Invention

This invention relates to the packaging of electronic components using lead-free structures and materials.

2. Description of the Related Art

In the electronics industry, it is often necessary to attach chip packages and bare die to printed circuit boards (PCBs). The attachment structures provide electrical connections as well as mechanical support. Thermal management is also an issue in these systems. Circuit boards are often constructed of organic materials with relatively high coefficients of thermal expansion (CTEs), while ceramic chip carriers have relatively low CTEs. Thermal expansion mismatch can cause mechanical reliability problems such as metal fatigue. For some applications the thermal mismatch can be accommodated more easily using column grid array attachment techniques than using ball grid arrays.

In the past, many attachment structures used lead-containing solders. More recently it has been recognized as important to reduce the quantity of hazardous material used in many industries, including the electronics industry. Solders based on alloys of tin, silver, and copper have found use as lead-tin substitutes. The system is often referred to as “S-A-C” after the first letters of the chemical symbols for the constituents: Sn(tin)-Ag(silver)-Cu(copper). NEMI has, in fact, promulgated proposed standard solder formulations, including binary compositions of 0.7% Cu in Sn and 3.5% Ag in Sn for wave soldering, and a ternary alloy containing 3.9% Ag and 0.6% Cu in Sn for solder reflow. It is customary in this art to cite composition by weight or mass, so that 100 grams of the ternary reflow solder contain 95.5 g Sn, 3.9 g Ag, and 0.6 g Cu. The S-A-C eutectic composition of 95.42% Sn, 3.73% Ag, and 0.85% Cu, as reported by NIST, has a melting point of approximately 216° C.

### SUMMARY

Techniques have been developed to provide, in some embodiments, an attachment structure for mechanically and electrically connecting substrates that is robust to differences in coefficients of thermal expansion. In some embodiments the substrates may be electronic packages, including packaged integrated circuits (ICs) and bare die, to be attached to next-level packaging structures. In some embodiments the substrates may be electronic packages to be attached to other electronic packages. In some embodiments the substrates may be printed circuit boards (PCBs) to be attached to other PCBs.

In some embodiments lead-free alloy columns are joined to bonding pads on electronic packages having relatively low coefficients of thermal expansion (CTEs) using Pb-free solder from the same alloy system. In some embodiments Pb-free alloy columns are joined to bonding pads on printed circuit boards (PCBs) having relatively high CTEs using Pb-free solder from the same alloy system. In some embodiments the Pb-free columns soldered at one end to the low-CTE packages and at the other to the high-CTE boards accommodate the thermal expansion mismatch between the packages and boards while providing good electrical contact between the corresponding bonding pads.

In some embodiments, a thermal hierarchy in the tin-silver-copper (Sn—Ag—Cu or SAC) ternary alloy system is provided. In some embodiments a column is formed from an off-eutectic SAC alloy composition having a liquidus temperature exceeding 300° C. and is attached between an electronic package and a PCB using two distinct SAC solders having off-eutectic alloy compositions with distinct liquidus temperatures, both of which are lower than the column liquidus temperature.

In some embodiments techniques are provided for joining Pb-free alloy columns to an electronic package using a Pb-free composition from the same alloy system as the column. In some realizations, a method for joining Pb-free alloy columns to a PCB using a Pb-free composition from the same alloy system as the column is provided. In some realizations, a method for joining one end of a Pb-free alloy column to an electronic package and the other end to a PCB using two distinct Pb-free solders from the same alloy system as the column is provided.

In some embodiments an attachment system with a high-liquidus alloy column, an intermediate-liquidus solder, and a low-liquidus solder, all three of which components have compositions in the SAC alloy system, is provided.

The foregoing is a summary and thus contains, by necessity, simplifications, generalizations and omissions of detail. Consequently, those skilled in the art will appreciate that the foregoing summary is illustrative only and that it is not intended to be in any way limiting of the invention. The inventive concepts described herein are contemplated to be used alone or in various combinations. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art, by referring to the accompanying drawings.

FIGS. 1A-1C depict a chip carrier in stages of attachment to a printed circuit board using an alloy column and two solder compositions comprising elements of a common ternary alloy system.

FIGS. 2A and 2B depict enlargements of solder joints as depicted in FIGS. 1B and 1C.

FIGS. 3A-3C depict an electrical interconnection structure and its compositional variation.

FIGS. 4A-4C depict a printed circuit board in stages of attachment to a chip carrier using an alloy column and two solder compositions comprising elements of a common ternary alloy system.

FIGS. 5A and 5B depict an alloy column and a quantity of solder before and after, respectively, attachment.

FIG. 6 depicts an alloy column preform prior to attachment to a substrate.

FIG. 7 depicts an alloy column preform supported by a tape.

The use of the same reference symbols in different drawings indicates similar or identical items.

### DESCRIPTION OF THE PREFERRED EMBODIMENT(S)

Techniques have been developed to provide, in some embodiments, an advantageous series of lead-free alloy compositions useful in attaching packaged ICs, semiconductor die, and other chip carriers to printed circuit and printed wiring boards. In this context, and acknowledging that it is nearly impossible for electronics to be entirely free of lead, which is fairly ubiquitous in the environment, we apply the term “lead-free” to materials containing less than proposed maximum contaminant levels for compliance with the RoHS Directive and other local, national, and international environmental regulations. Currently these impurity levels (by weight) are 0.1 percent for Pb, Hg, Cr VI, polybrominated biphenyl (PBB), penta-polybrominated diphenyl ether (PBDE) and octa-PBDE, and 0.01 percent for Cd in each homogeneous material. The regulations and guidelines define a “homogeneous material” as a material that cannot be mechanically disjointed into different materials.

A ternary alloy system includes end members and binary compositions, in addition to ternary compositions. Using the SAC system as an example, pure Sn, pure Ag, and pure Cu may be said to be members of the system. Alloys, however, contain at least two elements, so that alloy members of a ternary alloy system comprise two or more elements. Binary compositions, such as 20 w/oAg in Sn, in a ternary alloy system contain only two of the three elements in amounts sufficient to alter the properties of the material. Although not present in all alloy systems, intermetallic compounds, e.g., Ag₃Sn, Cu₆Sn₅, and Cu₃Sn, in a ternary alloy system may contain two or three of the constituent elements, in a ratio that has such a small range it is treated as fixed, i.e., the compound is treated as having no variation in composition. Ternary compositions contain all three end members in amounts large enough to affect the properties of the material, that is, in more than trace or contaminant amounts.

While the alloy compositions are described as members of a ternary alloy system, useful compositions may comprehend small amounts of additional elements, whether added intentionally or present as unavoidable impurities. No doubt persons of ordinary skill in the art following the teaching herein and in the course of ordinary experimentation will find useful variations on the examples given. Nonetheless, the scope of the invention is to be understood as limited only by the appended claims.

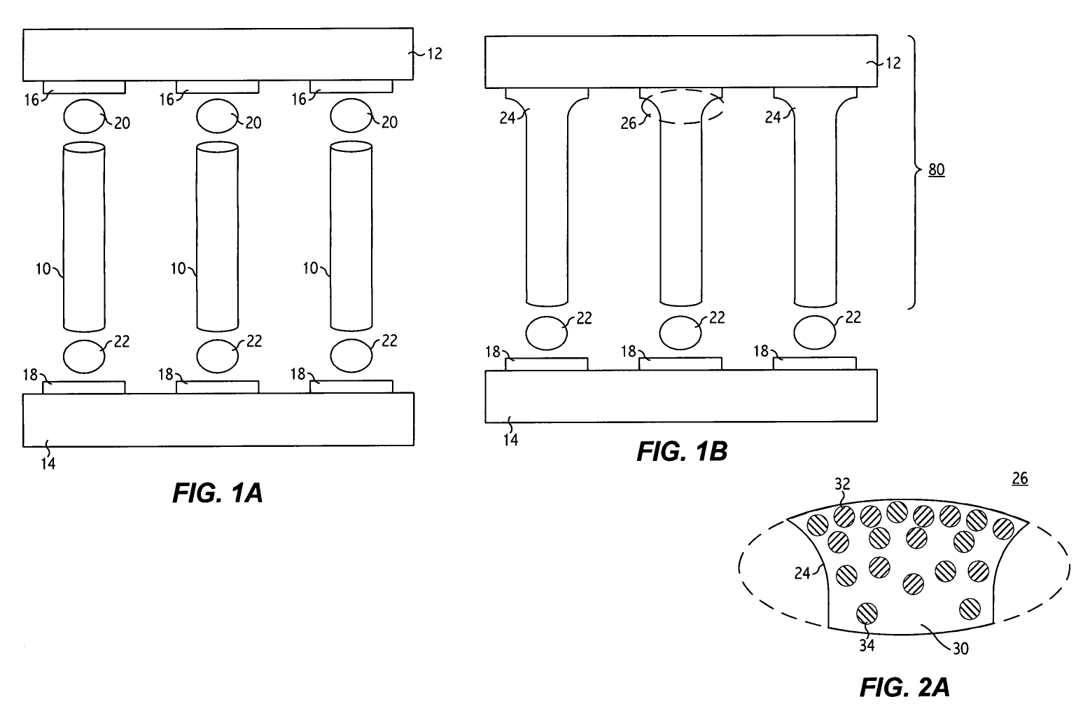

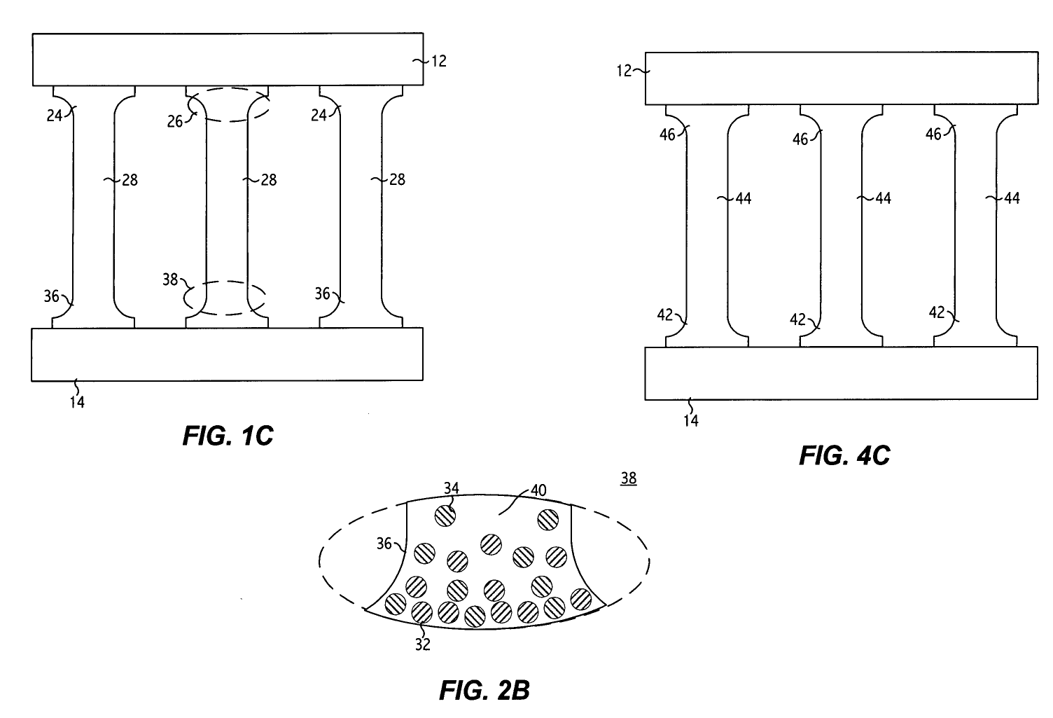

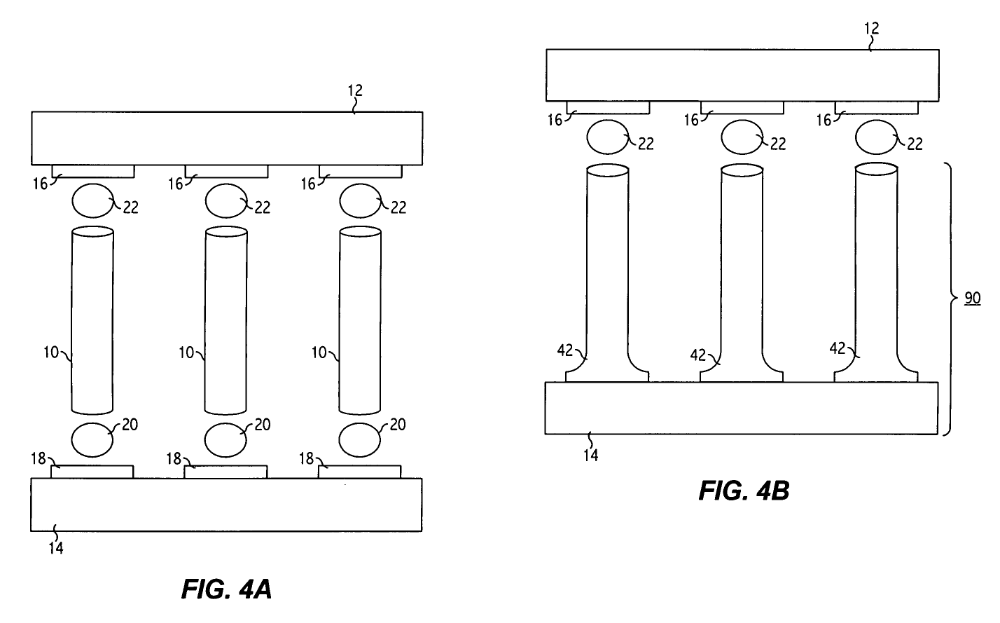

The drawing figures provided are simplified and, as usual in the art, not to scale, but depict relationships between structural elements. For example, the separation of alloy columns and quantities of solder from other structures as in FIGS. 1A and 4A is not meant to imply that these elements exist unsupported, but rather offers a clarification of the relationship of the individual elements to the finished structure.

### EXAMPLE 1

FIG. 1A depicts a chip carrier before attachment to a printed circuit board using an alloy column and two solder compositions comprising elements of a common ternary alloy system. In one preferred embodiment, a column 10 for attaching a chip carrier 12 to a printed circuit board (PCB) 14 is formed from approximately 80 percent by weight (80 w/o) tin and 20 w/o silver. This composition has a liquidus temperature of approximately 380-385° C. and a solidus temperature of approximately 230° C. The column 10 may be formed by any suitable method. For example, column 10 may be cast or cut from wire or ribbon, using any of the techniques standard in the solder industry. One end of the column is to be attached to the chip carrier 12 with a quantity of solder 20 and the other end to the PCB 14 with a quantity of solder 22. Generally both chip carriers and PCBs have solderable bonding pads 16, 18 for attaching one to the other and allowing for input and output operations. Often the bonding, or I/O, pads have a high copper or nickel content. Referring to FIG. 1B, the alloy column 10 is attached to a bonding pad 16 on the chip carrier using a solder 20 to form a joint 24, whose structure 26 is described in more detail with reference to FIG. 2A. The solder 20 in this example has a composition of approximately 91 w/o tin, 7 w/o silver, and 2 w/o copper, having a liquidus temperature of approximately 272° C. and a solidus temperature of approximately 216° C. Referring to FIG. 1C, the other end of the alloy column 10 is then attached to a bonding pad 18 on the PCB 14 using a solder 22 to form a joint 36, whose structure 38 is described in more detail with reference to FIG. 2B. The solder 22 in this example has a composition of approximately 96.5 w/o tin, 3.0 w/o silver, and 0.5 w/o copper, having a liquidus temperature of approximately 220° C. and a solidus temperature of approximately 216° C.

During the first soldering procedure, the molten solder 20 attains a temperature higher than its liquidus, but below the liquidus temperature of the alloy column 10. Heating the solder thus causes it to flow. The tip of the column 10 in contact with the molten solder 20 softens and mixing occurs locally. Copper from the solder 20 and, when present, the bonding pad 16, suppresses the solidus temperature of the tip of the column to the Sn—Ag—Cu eutectic temperature of approximately 216° C. As the solder joint 24 cools, a composition gradient develops from the 80-20 of the original column alloy through the 91-7-2 of the original high-temperature solder composition. Should the bonding pad 16 contain copper and/or silver, the pad also partially alloys with the solder resulting in another composition gradient. When the solder joint 24 cools below the Sn—Ag—Cu eutectic temperature, solidification is complete. The resulting joint structure 26, shown in FIG. 2A, has smooth transitions between the column 28, solder fillet 24, and bonding pad 16. A beta-Sn matrix 30 surrounds intermetallic phases 32, 34, that vary in local density as the composition changes.

During the second soldering procedure, the molten solder 22 attains a temperature higher than its liquidus, but below the liquidus temperature of both the alloy column 10 and the first solder junction 24. The tip of the column 10 in contact with the molten solder 22 softens and mixing occurs locally. Copper from the solder 22 and, when present, the bonding pad 18, suppresses the solidus temperature of the tip of the column 10 to the Sn—Ag—Cu eutectic temperature of approximately 216° C. As the solder joint 36 cools, a composition gradient develops from the 80-20 of the original column alloy through the 96.5-3.0-0.5 of the original lower-temperature solder composition. Should the bonding pad 18 contain copper and/or silver, it also partially alloys with the solder resulting in another composition gradient. When the solder joint 36 cools below the Sn—Ag—Cu eutectic temperature, solidification is complete. The resulting joint structure 38, shown in FIG. 2B, has smooth transitions between the column 28, solder fillet 36, and bonding pad 18. A beta-Sn matrix 40 surrounds intermetallic phases 32, 34, that vary in local density as the composition changes. Should rework be required, the chip carrier 12 and attached columns 28 can be removed from the PCB 14 by reflowing at a temperature well below the liquidus of the first solder junction 24, allowing the columns 28 to remain attached to the chip carrier 12.

In the completed structure of FIG. 1C, the column-and-solder attachment structure provides an electrically conducting path between the PCB 14 and the chip carrier 12. The attachment structure also provides mechanical support for the chip carrier. Differential expansion and contraction between the PCB 14 and the chip carrier 12 is accommodated by the attachment structure, which can bend without plastic deformation at a much higher strain level than a ball grid array (BGA) solder joint.

FIGS. 2A and 2B show greatly simplified versions of the microstructures of joints 26 and 38, respectively. The intermetallic compound Ag₃Sn tends to form platelets while Cu₅Sn₆ is more dendritic. Thus copper-rich intermetallic phase 32 has different morphology from silver-rich intermetallic phase 34. This use of ternary compositions for the solder materials in a thermal hierarchy allows for a greater degree of property tailoring than does the use of binary solders. For example, given a desired liquidus temperature, composition of the solder material may be chosen from the range having that liquidus temperature so as to optimize the ratio of constituent phases and adjust the morphology of the resulting joint. The SAC system is used merely as an example here; other ternary alloy systems form other intermetallic compounds and exhibit other morphologies.

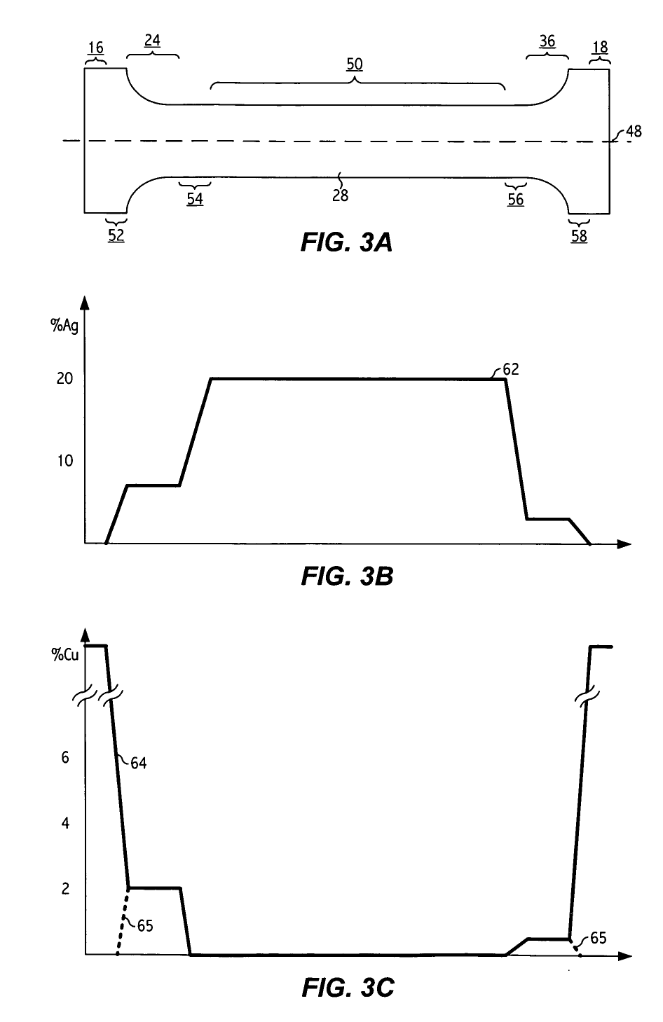

Joined alloy column 28 of FIG. 1C is reproduced in FIG. 3A. At each end of the column 28 are the parts of the original bonding pads 16, 18 left unaffected by the first and second soldering procedures, respectively. At the center of the column 28 is a region unaffected by either of the soldering processes, referred to hereafter as the body 50 of the column. The body 50 need not be symmetrically located with respect to the two solder joints 26 and 32. During soldering, transition regions form between relatively unaffected regions of the attachment structure. During the first soldering operation, transition region 52 forms between the bonding pad 16 and the high-temperature solder joint 26, while transition region 54 forms between the high-temperature solder joint 26 and the body 50 of the column. During the second soldering operation, transition region 56 forms between the low-temperature solder joint 36 and the body 50 of the column, while transition region 58 forms between the bonding pad 18 and the low-temperature solder joint 36.

FIGS. 3B and 3C depict typical Ag 62 and Cu 64 concentrations, respectively, found along the centerline 48 of joined alloy column 28 of FIG. 3A. These figures are, again, greatly simplified and are intended to facilitate explanation of the invention rather than to faithfully reproduce a particular concentration measurement. The two concentration scales are different and, for specificity, the bonding pads in this example are taken to contain virtually no silver and a high concentration of copper, indicated in FIG. 3C by the parallel lines breaking the Cu concentration line 64. As shown in FIG. 3B, the Ag concentration 62 goes from virtually zero in bonding pad 16, through a smooth transition to the nominal composition of 7 w/o of the higher-temperature solder within the joint 24, through a second transition to a peak value of 20 w/o in the body 50 of the alloy column, through another transition to the nominal composition of 3.0 w/o of the lower-temperature solder within the joint 36, and through a final transition, dropping to undetectable levels in the bonding pad 18. FIG. 3C shows that the concentration 64 of Cu starts out very high in bonding pad 16, through a smooth transition to the nominal composition of 2 w/o of the higher-temperature solder within the joint 24, through a second transition to a minimum value of approximately zero in the body 50 of the alloy column, through another transition to the nominal composition of 0.5 w/o of the lower-temperature solder within the joint 36, and through a final transition, reaching the very high concentration of the bonding pad material 18. If the bonding pad 16 is made of nickel or another solderable metal, the copper concentration drops to virtually zero in the pad, as shown by dotted line 65. The smooth variation of composition throughout the length of the attachment structure provides cohesion under conditions of thermal and mechanical stress.

### EXAMPLE 2

FIG. 4A depicts a chip carrier before attachment to a printed circuit board using an alloy column and two solder compositions comprising elements of a common ternary alloy system. The column 10 for attaching a chip carrier 12 to a printed circuit board (PCB) 14 is formed from an alloy of Ag in Sn with a composition higher in Ag than the Sn—Ag eutectic composition, having a liquidus temperature above about 300° C. Referring to FIG. 4B, one end of the alloy column 10 is attached to a bonding pad 18 on the PCB using a solder 20 with a composition significantly richer in both silver and copper than the SAC eutectic composition and having a liquidus temperature greater than approximately 240° C. and a solidus temperature of approximately 216° C., forming a high-temperature solder joint 42. To accomplish the attachment, the column 10 is aligned to a bonding pad 18, solder 20 is applied to the bonding pad 18, the column 10, or both, and the solder 20 is heated to a temperature above its solidus temperature. Several methods of aligning attachment columns to bonding pads and between chip carriers and PCBs are known in the art. After bonding, the system cools below the solidus temperature of the solder forming the solder joint 42.

As depicted in FIG. 4C, the other end of the alloy column 10 is then attached to a bonding pad 16 on the chip carrier 12 using a solder 22 with a composition significantly poorer in both silver and copper than the SAC eutectic composition and having a liquidus temperature less than approximately 232° C. and a solidus temperature of approximately 216° C., forming a lower-temperature solder joint 46, as described with reference to solder joint 42. Should rework be required, the chip carrier 12 can be removed from the PCB 14 and attached columns 44 by reflowing at a temperature well below the liquidus of the first solder junction 42, allowing the columns 44 to remain attached to the PCB 14.

### EXAMPLE 3

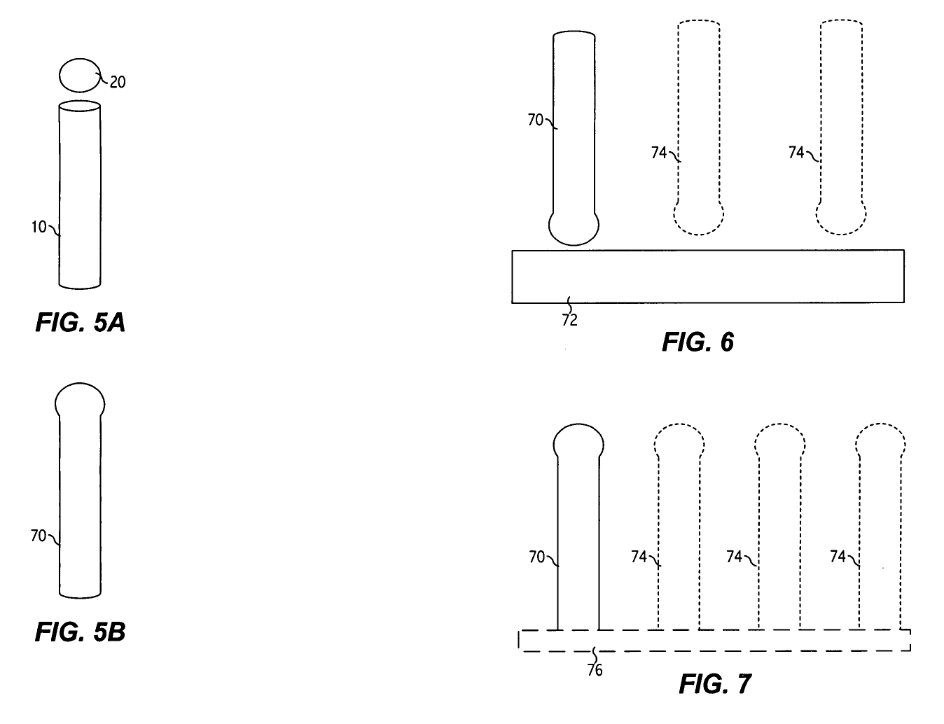

Alloy columns may be prepared for use by attaching the relatively high liquidus solder to one end of the column. Referring to FIG. 5A, the solder 20 can be attached to the alloy column 10, producing a column preform 70, shown in FIG. 5B. As shown in FIG. 6, the preform 70 can then be placed so the solder makes contact with a substrate 72, such as a PCB or a chip carrier, and the solder can be flowed to attach the column to the substrate. Additional preforms 74 may optionally be attached during the same or a subsequent bonding operation. FIG. 7 depicts a preform 70 attached to a tape 76 for use in tape automated bonding. The tape 76 may support many additional preforms 74.

### Other Embodiments

Alloy columns may be attached to substrates by putting a quantity of solder on the substrate (or bonding pad, if present), flowing the solder, contacting the molten solder with the column, and cooling the structure below the liquidus temperature of the solder and the solidus temperature of the column. The columns may also be attached by putting the solder first on the column, as described in Example 3, or by putting solder on both the column and the substrate, and then flowing the solder, contacting both column and substrate to the molten solder, and cooling the structure. If desired, the lower-temperature soldering process may be performed just subsequent to the completion of the higher-temperature soldering operation. Temperature ranges for soldering operations are chosen to avoid decomposition of the chip carriers and PCBs, and so depend on the materials employed. Cooling rates are also materials dependent, as excess thermal shock to the chip carriers and PCBs must be avoided.

In some realizations of these techniques it may be desirable to provide the attachment structure in parts, for subsequent joining. For example, lead-free alloy columns may first be attached to chip carriers using a relatively high-liquidus temperature solder from the same ternary alloy system as the column, forming subassembly 80 of FIG. 1B. The chip carriers, with attached columns, can then be bonded at a later time to a PCB, or other next-level structure, using a lower-liquidus temperature solder from the same ternary alloy system as the column and the first solder. In another embodiment, lead-free alloy columns may first be attached to a PCB or other attachment structure using a relatively high-liquidus temperature solder from the same ternary alloy system as the column, forming subassembly 90 of FIG. 4B. The PCB, with attached columns, can then be bonded at a later time to chip carrier(s) using a lower-liquidus temperature solder from the same ternary alloy system as the column and the first solder.

As mentioned elsewhere in this description, the compositions of the ternary solders, and, indeed, of the alloy column, can be chosen to provide a desired liquidus temperature. In some applications, the liquidus temperature itself may be an important parameter, such as when the highest temperature soldering operation must be accomplished at a low enough temperature than another element in the system does not degrade. In some applications the absolute difference between the liquidus temperatures of the alloy column and the ternary solders may be an important factor that drives the choice of compositions, as when the temperature of the soldering operations can be controlled only within a range of temperatures. In such a case, the compositions of the solder materials may be chosen to provide liquidus temperature differences greater than any fluctuation in temperature expected during soldering, for example, 5° C., 10° C., or even more depending on the soldering apparatus. In some applications the difference between the liquidus temperature of a solder and the eutectic temperature of the ternary alloy system may be an important parameter in the determination of optimal compositions. While solder compositions with the same, or nearly the same, liquidus temperatures may be successfully employed in joining chip carriers and PCBs, particularly when a relatively high-melting alloy column is used, rework is generally facilitated when the individual elements in the attachment structure have liquidus temperatures separated by several degrees.

In some embodiments, Cu may be added to the Sn/Ag alloy column. Addition of Cu improves tensile strength. In fact, near the 80-20 composition, the liquidus temperature of the alloy is relatively insensitive to small variations in composition as well as to additions of small amounts of copper. In some embodiments, the silver content of the column may be increased to as much as 50 w/o, or higher. Higher concentrations of Ag increase the liquidus temperature of the alloy, increasing the amount of solid phase present at a given temperature as well as the difference between the liquidus temperatures of the column and solder compositions. The attach point, or solder, compositions may also be varied somewhat as long as the compositions retain distinct liquidus temperatures, both lower than the liquidus temperature of the alloy column employed. Additional elements, such as In, Ga, Sb, and Bi, may be added to the SAC system without departing from the scope of the invention.

Other lead-free ternary alloy systems may be employed in addition to the Sn—Ag—Cu system. For example, the bismuth-silver-copper system has a eutectic temperature of about 262° C. and the bismuth-silver-tin system has a Bi-rich eutectic temperature of about 262° C. These systems may be employed for use at higher temperatures. The relatively Sn-rich compositions of the Bi—Ag—Sn ternary alloy system have a eutectic temperature of about 137° C., while the Bi—Cu—Sn system has a eutectic temperature of about 139° C. These systems may be employed for use at lower, even cryogenic, temperatures. Other examples of lead-free ternary alloy systems may include Sn—In—Ga, Sn—In—Sb, Sn—In—Bi, Sn—Ga—Sb, Sn—Ga—Bi, and Sn—Sb—Bi.

While the singular has generally been used for ease of description it should be understood that the invention, as limited only by the appended claims, encompasses plural instances and operations as well. For example, tapes of many alloy column preforms may be prepared and bonded at once to a substrate. Many columns may be attached to a substrate in a single operation. Many substrates may be attached to a common substrate using the alloy column and solder hierarchy in a single operation or serially.

What is claimed is:

1. An electrical interconnect structure comprising:
a Pb-free alloy column having a first liquidus temperature and a first solidus temperature; and
a quantity of Pb-free solder having a second liquidus temperature, the second liquidus temperature being lower than the first liquidus temperature and more than 10° C. higher than a eutectic temperature of the ternary alloy system;
wherein the alloy column and the solder comprise distinct off-eutectic compositions in a common ternary alloy system; and
wherein the solder composition comprises a ternary composition.

2. The structure of claim 1,
wherein the first liquidus temperature is greater than about 300° C.

3. The structure of claim 1,
wherein the solder has been joined to the column forming a unitary member having a graded composition.

4. The structure of claim 3,
wherein the alloy column is joined to the solder, forming a solderable preform.

5. The structure of claim 4, further comprising:
a carrier tape suitable for transporting and positioning the preform,
said preform attached to said carrier tape.

6. The structure of claim 1, further comprising:
a substrate joined to the solder.

7. The structure of claim 6, further comprising:
a second quantity of Pb-free solder having a third liquidus temperature, the third liquidus temperature being lower than the first and second liquidus temperatures;
wherein the second solder comprises a ternary off-eutectic composition in the common ternary alloy system.

8. The structure of claim 7, wherein the common ternary alloy system comprises the Sn—Ag—Cu system.

9. The structure of claim 8, wherein:
the first solder comprises a composition significantly richer in Ag and Cu than a ternary Sn—Ag—Cu eutectic composition; and
the column comprises a composition significantly richer in Ag than a binary Sn—Ag eutectic composition and virtually entirely depleted of Cu.

10. The structure of claim 8, wherein the alloy column has a composition of about 80% Sn and about 20% Ag by weight.

11. The structure of claim 8, wherein the first solder has a composition of about 91% Sn, about 7% Ag, and about 2% Cu by weight.

12. The structure of claim 8, wherein the second solder has a composition of about 96.5% Sn, about 3.0% Ag, and about 0.5% Cu by weight.

13. The structure of claim 7, further comprising:
a second substrate joined to the second solder.

14. The structure of claim 13,
wherein the solders and the column provide a continuous electrically conducting path between the first substrate and the second substrate.

15. A method for forming a Pb-free electrical interconnection structure, the method comprising:
attaching a quantity of a first solder to a first end of an alloy column,
the alloy column having an off-eutectic composition in a ternary alloy system, said column composition having a liquidus temperature and a solidus temperature; and
the first solder having an off-eutectic ternary composition in the ternary alloy system, said first solder composition having a liquidus temperature lower than the column liquidus temperature and more than 10° C. higher than a eutectic temperature in the ternary alloy system.

16. The method of claim 15, further comprising:
attaching a first substrate to the first solder.

17. The method of claim 15, further comprising:
attaching a quantity of a second solder to a second end of the column,
the second solder having an off-eutectic composition in the ternary alloy system, said second solder composition having a liquidus temperature lower than the first solder composition liquidus temperature.

18. The method of claim 17, further comprising:
attaching a second substrate to the second solder.

19. The method of claim 16, further comprising:
attaching a quantity of a second solder to a second substrate,
the second solder having an off-eutectic composition in the ternary alloy system, said second solder composition having a liquidus temperature lower than the first solder composition liquidus temperature.

20. The method of claim 19, further comprising:
attaching the second substrate to a second end of the column.

21. The method of claim 20, wherein the attaching of the second substrate to the column comprises:
flowing the second solder;
contacting the second substrate and the second end of the column with the flowing solder; and
cooling the second solder below a eutectic temperature of the ternary alloy system.
